(19) United States
(12) Patent Application Publication
(10) Pub. No.: US 2014/0377723 A1
(43) Pub. Date: Dec. 25, 2014

(54) METHOD AND TOOL FOR TECHNOLOGIST ONBOARDING AND PROFESSIONAL DEVELOPMENT

(71) Applicants: Margaret A. Strong, Spicewood, TX (US); Gwendolyn P. Roberts, San Jose, CA (US); Jon Franklin Allen, San Jose, CA (US)

(72) Inventors: Margaret A. Strong, Spicewood, TX (US); Gwendolyn P. Roberts, San Jose, CA (US); Jon Franklin Allen, San Jose, CA (US)

(73) Assignee: EBAY INC., SAN JOSE, CA (US)

(21) Appl. No.: 14/133,415

(22) Filed: Dec. 18, 2013

Related U.S. Application Data
(60) Provisional application No. 61/839,192, filed on Jun. 25, 2013.

(51) Int. Cl. G09B 19/00; G09B 7/08

(52) U.S. Cl. CPC G09B 19/0053; G09B 7/08
USPC 434/118

(57) ABSTRACT

In an example embodiment, errors in software may be monitored to identify types for the errors and individual programmers responsible for the errors. Then a customized learning plan for online education may be created for one or more individual programmers based on the types of errors identified by the bug tracking module and the individual programmers responsible for those errors.

### TECHNICAL FIELD

This application relates generally to learning management systems. More particularly, this application relates to a method and tool for technologist onboarding and professional development.

### BACKGROUND

A learning management system is a software application used for the administration, documentation, tracking, reporting, and delivery on e-learning education courses or training programs. Learning management systems can be used by colleges and universities to offer online courses, but also can be used by corporate training departments to deliver online training, as well as automate record-keeping and employee registration.

Learning management systems generally include frameworks to handle all aspects of the learning process. It can deliver and manage instructional content, identify and assess individual and organizational learning or training goals, track the progress towards meeting those goals, and collect and present data for supervising the processes of organizations as a whole. As such, a learning management process can not only deliver content but also handle registering for courses, course administration, skills gap analysis, tracking, and reporting.

In the corporate world, current learning management systems are difficult to use and non-learner or non-manager centric. Technologists at companies can often be adverse to working with learning management systems, rather relying on word-of-mouth, wikis, and other informal means to pass valuable enterprise learning.

### BRIEF DESCRIPTION OF DRAWINGS

FIG. 1 is a block diagram illustrating an education system in accordance with an example embodiment.

FIG. 2 is a screen capture illustrating a user management user interface in accordance with an example embodiment.

FIG. 3 is a screen capture illustrating an email template screen that may be used to automatically generate emails to new hires in accordance with an example embodiment.

FIG. 4 is a screen capture illustrating a course curriculum screen in accordance with an example embodiment.

FIG. 5 is a screen capture illustrating an example interface that aligns with a corporation's job-role based competency system in accordance with an example embodiment.

FIG. 6 is a flow diagram illustrating a method in accordance with an example embodiment.

FIG. 7 is a block diagram illustrating a mobile device, according to an example embodiment.

FIG. 8 is a block diagram of machine in the example form of a computer system within which instructions may be executed for causing the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

In an example embodiment, a centralized yet flexible tool and method are provided that can be driven by technologists, assisted by a learning team, in order to help bring value and faster time to competency in key training areas. A customized learning portal paces the learner in control of what they need to do to make themselves and their teams succeed.

In an example embodiment, a number of different user roles interact through the portal, sharing some functionality but separating workflows and keeping a simplistic approach to learning, which can be both self-service and prescribed through job-role-aligned and initiative-aligned learning plans.

In an example embodiment, the system monitors search terms entered by learners and potential learners and determines search terms that have no corresponding learning document or plan within a learning system. These search terms may be referred to as null search terms. The system can then use these null search terms in forecasting what types of learning documents and plans are needed but not available.

On another example embodiment, a new hire date is tracked in a software asset management (SAM) system, and this date is linked to an attribute in the learning management system, so that there is no lag time in sending new hires a link to the learning portal with a learning plan custom-tuned to their teams' goals.

In another example embodiment, a learning portal also involves the manager by allowing them to track their team's progress through a learning plan with quick reference heat maps, and also allowing the exporting of data to other data management tools.

In another example embodiment, the registration process is reduced or eliminated. Simply by placing a course (live, online, or blended) on a learning plan, a learner is automatically registered for the course.

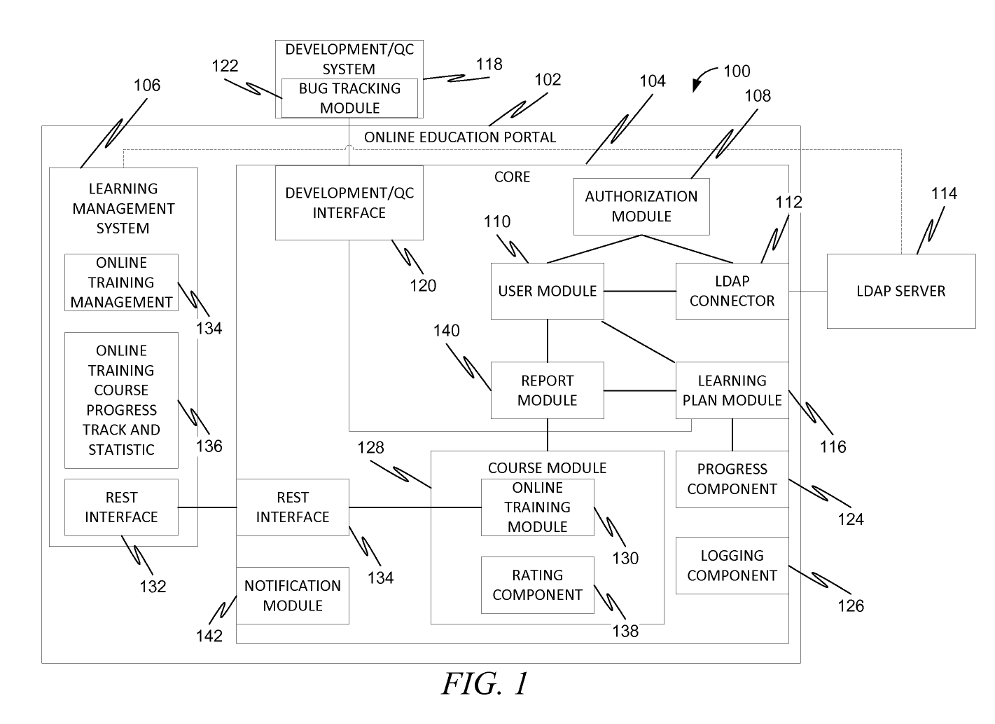

FIG. 1 is a block diagram illustrating an education system 100 in accordance with an example embodiment. The education system 100 may include an online education portal 102, which may contain a core 104 and a learning management system 106. The learning management system 106 may be, for example, a web application that is used to create online learning sites. The core 104 may contain an authorization module 108. The authorization module 108 may be used to authorize users of the online education portal 102. In an example embodiment, the authorization module 108 provides a single sign-on (SSO) authentication process, where the user can provide a single user name/password or other verification technique and gain access to multiple different components.

A user module 110 may maintain information about various users including, for example, an indication of a customized learning plan for each user, and access rights to various components in the system. User information may be retrieved, in part, from a Lightweight Directory Access Protocol (LDAP) server 112 via an LDAP connector 114.

A learning plan module 116 may construct a customized learning plan for each user. In an example embodiment, information from a development/Quality Control (QC) system 118 may be utilized by the learning plan module 116 (via a development/QC interface 120) in creating the customized learning plans. In a further example embodiment, the information from the development/QC system 118 is actually information gathered by a bug tracking module 122. The bug tracking module collects information about errors that are found in computer code and information about which user(s) caused such errors. In this way, the learning plan module 116 is able to create a customized learning plan for a user dynamically based on errors the user has made.

A progress component 124 may track each user's progress through the learning plan. For example, if the user has completed 2 of 8 modules customized for the user, then the progress component 124 may track this information, allowing for progress updates to the user or the user's supervisor, as well as allowing the user to automatically pick up where he left off in future training sessions. A logging component 126 may be used to track all actions taken by the user in the online education portal 102.

A course module 128 may maintain course materials in an online training module 130, which may interface with a representational state transfer (REST) interface 132 on the learning management system 106 via a REST interface 134 in the core 104.

The learning management system 106 may contain an online training management component 134, which manages the online training itself, and an online training course progress track and statistic module 136, which tracks the progress of the user and measures various statistics (e.g., correct answers in response to quizzes, time spent on each module or component of the learning plan, etc.). This information may then be passed to the progress component 124 of the core 104.

A rating component 138 in the course module 128 then provides a rating to each user. This rating may provide a summary of an evaluation of the user's capabilities in response to the online training, based, for example, on answers to quiz questions, progress, time spent on each module, and any other factors relevant to the user's capabilities.

A report module 140 may generate one or more reports about the learning plan and/or progress and rating of the users. These reports may be sent to the user or other relevant entities (e.g., user's supervisor, training coordinator, etc.) via a notification module 142.

The following are example use cases.

In a first example, an employee keys a Uniform Resource Locator (URL) into a browser, and the online education portal 102, through Single Sign On (SSO) via the authorization module 108, authenticates and recognizes the privilege level of the user through a job role attribute.

The SSO identifies users as having one of the four user roles available through the portal. With only one log in, users can see and function as multiple agents simultaneously. All users can be presented with the correct version of the portal based upon their SSO login.

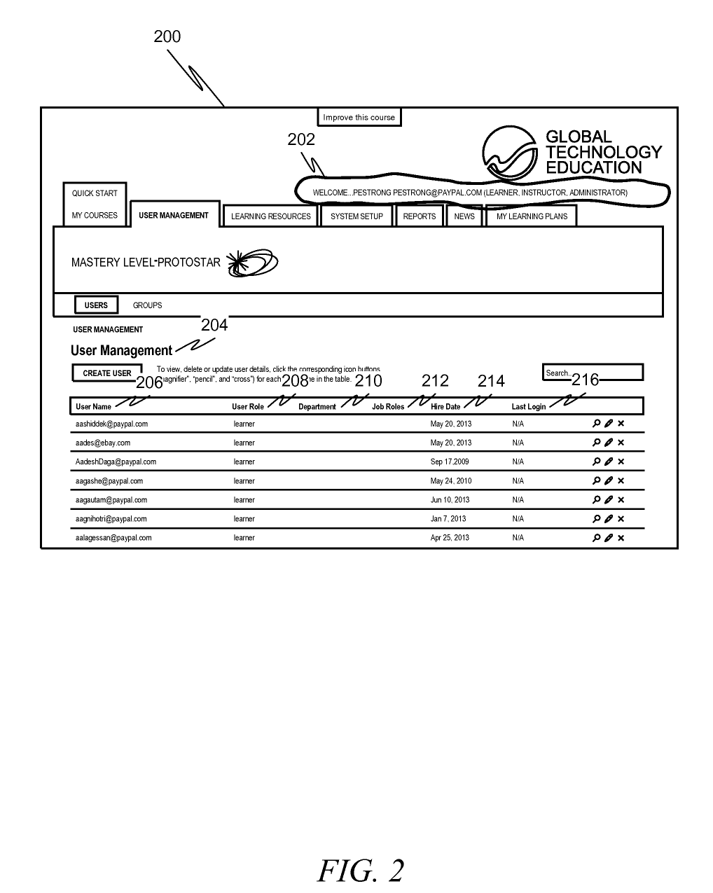

FIG. 2 is a screen capture illustrating a user management user interface 200 in accordance with an example embodiment. Here, a user who has logged in is presented with an indication of authorized roles 202. In this example, the user is authorized as a learner, instructor, and administrator. Because the user here has administrator rights, he or she is able to view user management information 204 about different users. This user management information 204 may include user name 206, user role 208, department 210, job role 212, hire date 214, and last login 216

In another example embodiment, a new hire is connected automatically to learning and is on the road to competency on Day 1, due to the fact that the LDAP server 114 communicates this information to the user module 110, rather than have the system take weeks to identify and engage the new hire in technical onboarding.

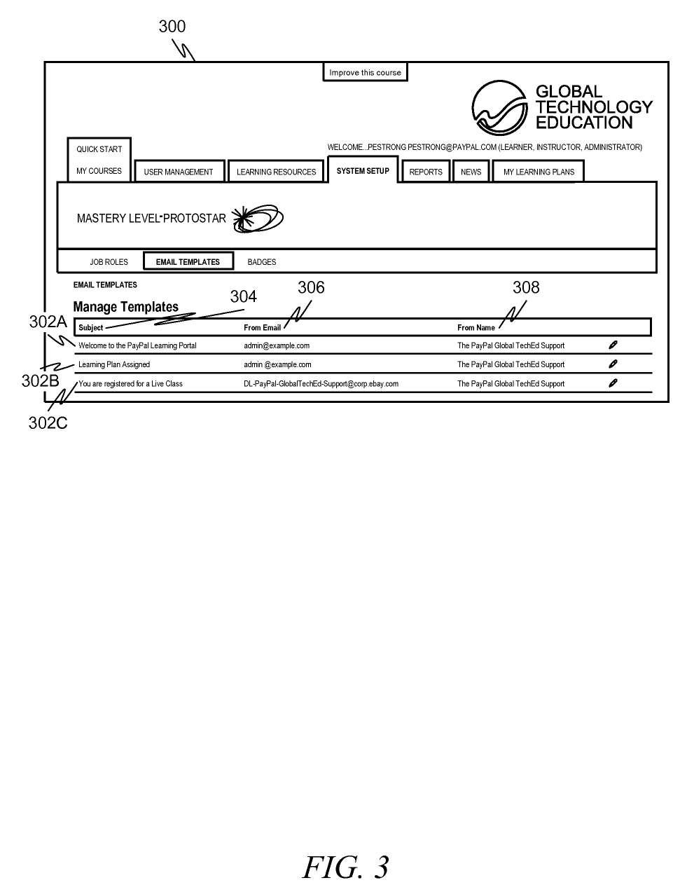

Additionally, there is no lag time in sending new hires a link to the learning portal with a learning plan custom-tuned to their teams' goals. A new hire is engaged with the portal leading to a faster time to competency. Emails are automatically generated and can be edited within the learning portal by administrators. FIG. 3 is a screen capture illustrating an email template screen 300 that may be used to automatically generate emails to new hires in accordance with an example embodiment. The email template screen 300 depicts various created templates 302A, 302B, 302C. Each template 302A, 302B, 302C may have a subject 304, a from email 306, and a from name 308 that can be viewed, and the templates themselves 302A, 302B, 302C may be edited.

In another example embodiment, the learning plan module 116 can derive a learning plan based at least in part on null search terms. This means that user search queries can be tracked, and searches that result in no search results (null search terms) can be identified. Tracking null search terms can forecast what learning is needed but not available. Learning plans originate with the team and their manager, not the administrator, so emergent knowledge is caught early in the knowledge lifecycle and can be spread throughout the organization by the administrator.

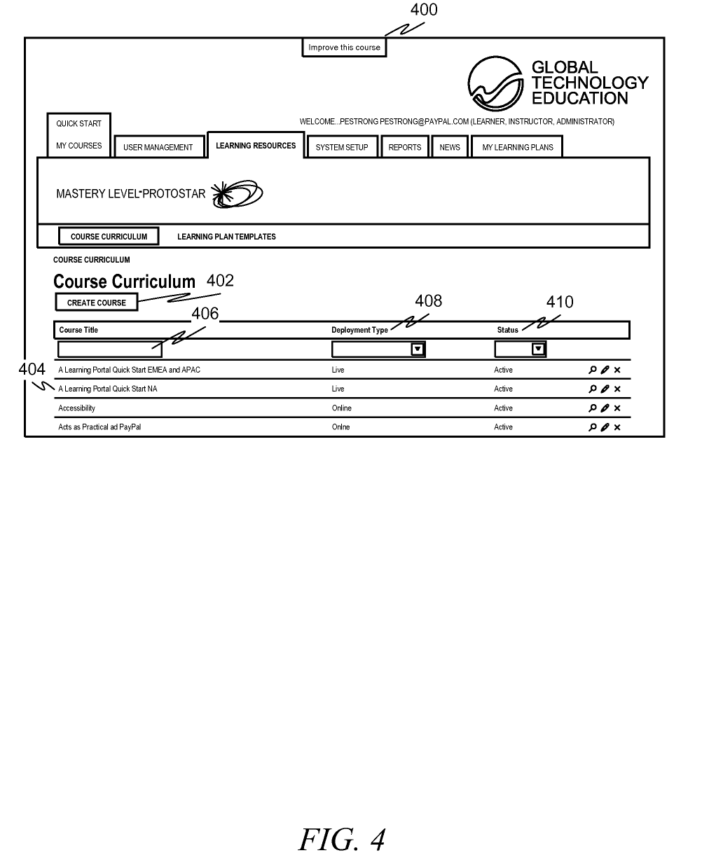

FIG. 4 is a screen capture illustrating a course curriculum screen 400 in accordance with an example embodiment. Here, an administrator may create a course 402 as well as manage existing courses 404. Various information about the existing courses 404 may be presented, including course title 406, deployment type 408, and status 410.

In another example use case, the unique needs of teams working within domains in online financial transaction processing requires individualized learning plans for new hires and others, assembled by managers who know their teams' needs and want to quickly spot learning progress.

In another example use case, in the competitive Information Technology (IT) Web Services climate, it may not be desirable to house proprietary information on external servers with varying degrees of security. Instead, the learning portal can be integrated wholly and directly into the corporate environment. Huge course enrollments can be quickly deployed without service level agreements or third party availability issues—such as are often encountered with Massive Online Open Courses (MOOCs).

The online education portal 102 can be integrated into the corporate environment through SSO and is installed on an internal cloud through virtual machines in its data center. This differs from conventional models of Learning Portals over learning management system configurations, which are typically on shared physical server, in hosted environments, which cuts back on the ability to scale quickly in response to heavy volumes of learners such as those enrolling in MOOCs. Additionally, the portal can support emergent technologies such as the Activity application program interface API, allowing learners to matriculate multiple modalities of learning. The inside-the-firewall hosting also protects any proprietary information far more securely than storing it on a 3rd-party vendors' servers.

In another example use case, historical skills data and course usage data e can be used for assessing new candidates' job requirements.

In another example embodiment, a cloud-based Learning Portal tool, when paired with other similar configurations, can provide technical managers and job recruiters with an advantage of filling internal or external positions intra- or inter enterprise. By analyzing learner profiles and learning plans, which are aligned with internal professional development competencies, openings can be filled with the very technologists actively developing themselves towards the skills needed for professional advancement. Additionally, coding artifacts as part of real-work or simulated application of skills learned in technology-based courses can be analyzed for job suitability, giving a far more accurate perspective of a candidate's demonstrated talent. Prospective candidates could be pushed to recruiters on the basis of real, demonstrated skills and professional development rather than on resumes alone.

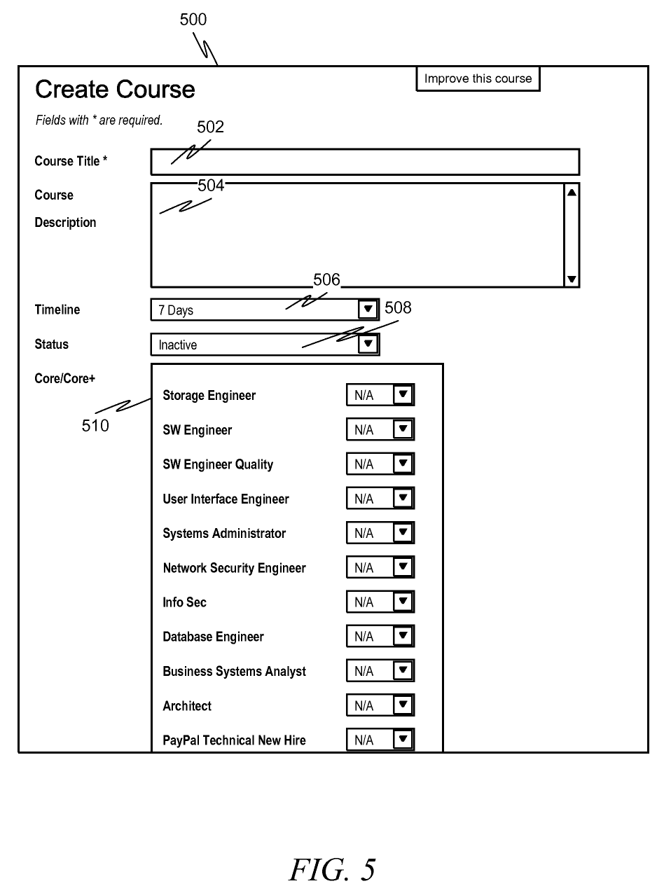

FIG. 5 is a screen capture illustrating an example interface 500 that aligns with a corporation's job-role based competency system in accordance with an example embodiment. Use Case: Aligning with technical business and skill development needs by integrating with existing tools and apps providing learning gap analyses. Here, the interface 500 provides the ability for the user to enter a course title 502 and description 504, set a timeline 506 for the course, set a status 508 for the course, and set various core job requirements 510 for those who take the course.

Software development shops typically have has a centralized bug tracking tool. Software bugs are spotted, tickets submitted, and bugs fixed; however, little effort is ever made at tracking the source of a bug and providing remediation to the technologist whose skills may need sharpening. As described earlier, the learning plan module 116 can be built out to suggest courses to learners and their managers by analyzing reports from bug trackers, front line help tickets, continuous integration tracking software conflicts, and other problems. This prescriptive learning engine is far different than the top-down method of only gathering learning needs from executives and technical leaders setting business strategy, which is common in the IT industry. Additional learning solutions could now be developed and delivered on tangible business needs supplied by the development tools themselves, automating the manual effort of tedious learning gap analyses—and having learning solutions make a direct impact on the bottom line.

In another example use case, learners often need motivation to complete learning plans and courseware. Two elements within the Learning Portal support in a novel way the concept of gamification. Gamification is the use of game thinking and game mechanics in a non-game context in order to engage users and solve problems. The badging system, typically affecting an intrinsic motivation to visually display personal achievement, can be taken several steps further by administrative analysis of badge status with learning plan content and completion rates across an enterprise or inter-enterprise. This analysis could yield learner behaviors that would provide a meaningful pairing for more successful mentoring and coaching programs. In other words, there is now a way to track technologists focusing on similar skill development paths and pair them, based on beginner/advanced badges, into complementary coaching relationships. The second aspect of gamification would be the comparison of learners' progress through cumulative learning plans in a scoreboard feature across teams, business units, or inter-Enterprise.

In another example use case, efficiencies in meeting room planning can be improved. Buildings at corporate campuses, and the campus' themselves, can be difficult to negotiate. For a live, instructor-led class the auto-scheduler in the tool can compare the registrants'/learners' schedules and locations and notify the registrant and instructor that individuals might not make it to class by start time, and suggest an alternative or delayed start time or suggesting meeting/classrooms that are in proximity to all, eliminating time and space conflicts.

In another example use case, attrition after registration is of concern to many engaged in their learning plans. This causes a lot of monetary loss to learning programs (hiring facilitators, planning meetings, travel, etc.). However, this data is rarely tracked or analyzed for root cause. In an example embodiment, a tool will analyze the speed upon which courses and learning plans are completed, track attrition across teams and individuals, and alert the administrator or manager when trends are spotted.

In another example user case, a tool can tap into learning management systems and can be installed over an open source system used to house online learning. However, the tool can be readily detached for repurposing or for standing alone to deliver live learning events. Other learning portals are tightly coupled to learning management systems; this portal is flexible.

In another example use case, presently, technologists are made to drop what they are doing and go to isolated, expensive, and hosted learning management systems. This interrupts their workflow, adds unnecessary expenditures to operating budgets, and contradicts the learning models that digital natives are bringing with them to the 21st century workplace. In an example embodiment, a tool integrates learning systems directly within the development/QC environment, supporting emergent cognitive theory, efficient work behaviors, and exploiting development tool/applications beyond their original functionality. The cost savings to software development organizations across industries would be substantial with a direct effect on productivity.

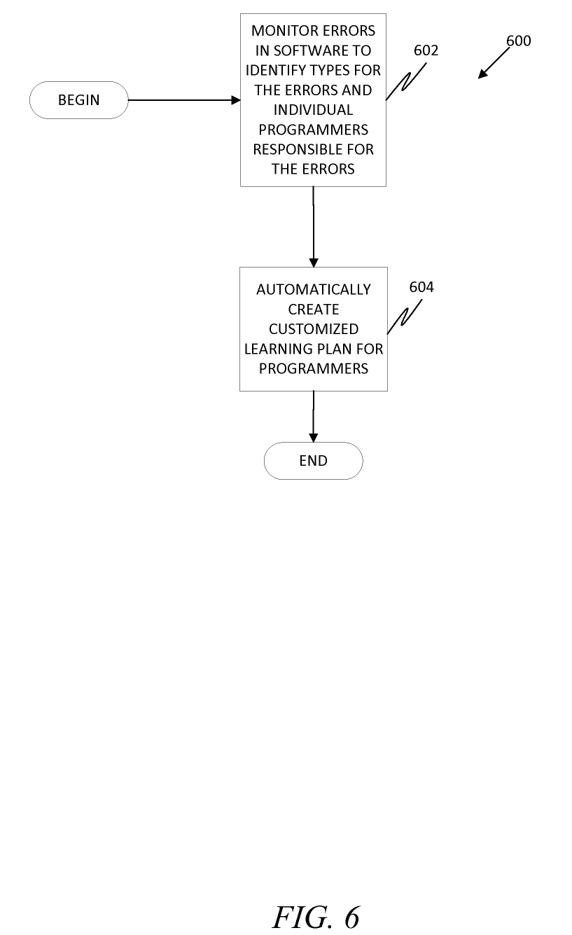

FIG. 6 is a flow diagram illustrating a method 600 in accordance with an example embodiment. At operation 602, errors may be monitored in software to identify types for the errors and individual programmers responsible for the errors. At operation 604, a customized learning plan may be automatically created for one or more programmers based on the identified types for the errors and individual programmers responsible for the errors.

### Example Mobile Device

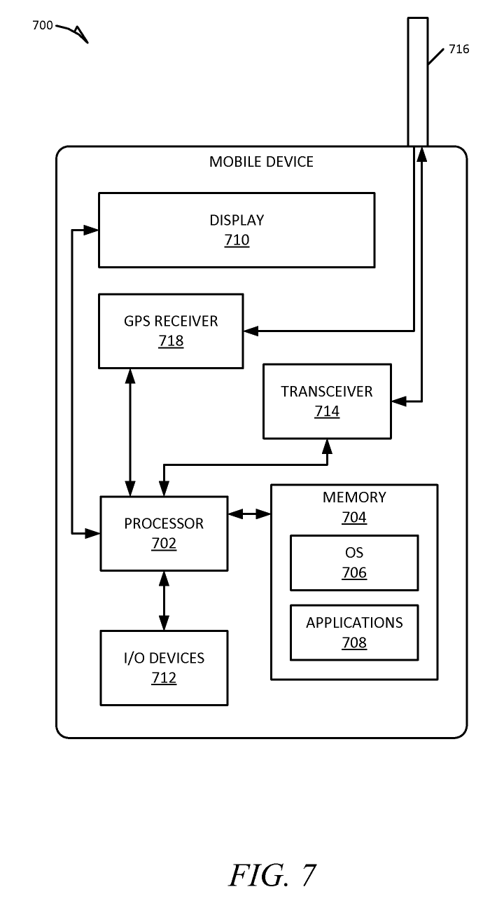

FIG. 7 is a block diagram illustrating a mobile device 700, according to an example embodiment. The mobile device 700 may include a processor 702. The processor 702 may be any of a variety of different types of commercially available processors suitable for mobile devices (for example, an XScale architecture microprocessor, a microprocessor without interlocked pipeline stages (MIPS) architecture processor, or another type of processor 702). A memory 704, such as a random access memory (RAM), a flash memory, or other type of memory, is typically accessible to the processor 702. The memory 704 may be adapted to store an operating system (OS) 706, as well as application programs 708, such as a mobile location enabled application that may provide LBSs to a user. The processor 702 may be coupled, either directly or via appropriate intermediary hardware, to a display 710 and to one or more input/output (I/O) devices 712, such as a keypad, a touch panel sensor, a microphone, and the like. Similarly, in some embodiments, the processor 702 may be coupled to a transceiver 714 that interfaces with an antenna 716. The transceiver 714 may be configured to both transmit and receive cellular network signals, wireless data signals, or other types of signals via the antenna 716, depending on the nature of the mobile device 700. Further, in some configurations, a GPS receiver 718 may also make use of the antenna 716 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors 702 may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure processor 702, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors 702 that are temporarily configured (e.g., by software) or permanently configured to perform the relevant operations. Whether temporarily or permanently configured, such processors 702 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 702 or processor-implemented modules. The performance of certain of the operations may be distributed among the one or more processors 702, not only residing within a single machine, but deployed across a number of machines. In some example embodiments, the processor 702 or processors 702 may be located in a single location (e.g., within a home environment, an office environment or as a server farm), while in other embodiments the processors 702 may be distributed across a number of locations.

The one or more processors 702 may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor 702, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors 702 executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 702), or a combination of permanently and temporarily configured hardware may be a design choice. Below are set out hardware (e.g., machine) and software architectures that may be deployed, in various example embodiments.

### Example Machine Architecture and Machine-Readable Medium

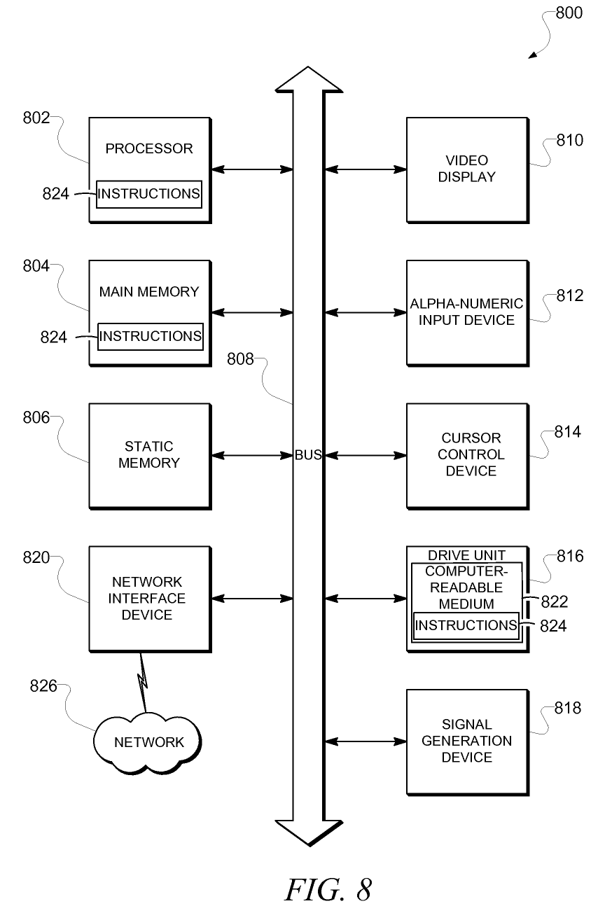

FIG. 8 is a block diagram of machine in the example form of a computer system 800 within which instructions 824 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard or a touch-sensitive display screen), a user interface (UI) navigation (e.g., cursor control) device 814 (e.g., a mouse), a disk drive unit 816, a signal generation device 818 (e.g., a speaker) and a network interface device 820.

### Machine-Readable Medium

The disk drive unit 816 includes a computer-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting computer-readable media 822.

While the computer-readable medium 822 is shown in an example embodiment to be a single medium, the term “computer-readable medium” may include a single medium or multiple media (e.g., a centralized or distributed database, and/or associated caches and servers) that store the one or more instructions 824 or data structures. The term “computer-readable medium” shall also be taken to include any tangible medium that is capable of storing, encoding or carrying instructions 824 for execution by the machine and that cause the machine to perform any one or more of the methodologies of the present disclosure or that is capable of storing, encoding or carrying data structures utilized by or associated with such instructions 824. The term “computer-readable medium” shall accordingly be taken to include, but not be limited to, solid-state memories, and optical and magnetic media. Specific examples of computer-readable media 822 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 824 for execution by the machine, and includes digital or analog communications signals or other intangible media to facilitate communication of such software.

Although the inventive subject matter has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A system comprising:
a memory;
a bug tracking module configured to monitor errors in software and to identify types for the errors and individual programmers responsible for the errors; and
a learning management module executable by a processor and configured to automatically create a customized learning plan for online education for one or more individual programmers based on the types of errors identified by the bug tracking module and the individual programmers responsible for those errors.

2. The system of claim 1, wherein the bug tracking module is part of a development or quality control system used to create the software.

3. The system of claim 1, further comprising a server containing information about one or more individual programmers, the server in communication with the learning management module to communicate the information for use by the learning management module in creating the customized learning plan.

4. The system of claim 3, wherein the information includes job description.

5. The system of claim 3, wherein the information includes start date.

6. The system of claim 3, wherein the server is a lightweight directory access protocol (LDAP) server.

7. The system of claim 1, further comprising an authorization module configured to grant access to one or more of the individual programmers to a plurality of components using a single sign-on (SSO).

8. The system of claim 1, wherein the learning plan includes a plurality of online courses where each online course is selected based on frequency of errors exceeding an error threshold for the corresponding online course.

9. A method comprising:
monitoring errors in software to identify types for the errors and individual programmers responsible for the errors; and
automatically create a customized learning plan for online education for one or more individual programmers based on the types of errors identified by the bug tracking module and the individual programmers responsible for those errors.

10. The method of claim 9, wherein the monitoring of errors includes using a bug tracking module in a development or quality control system used to create the software.

11. The method of claim 9, further comprising retrieving additional information about the one or more individual programmers from a server and utilizing the additional information when automatically creating the customized learning plan.

12. The method of claim 11, wherein the additional information includes job description.

13. The method of claim 11, further comprising providing a user interface for an administrator to create courses for use in learning plans, the user interface including one or more selectable menus for selecting job descriptions corresponding to created courses.

14. The method of claim 11, further comprising generating a report indication progress of the one or more individual programmers through corresponding customized learning plans.

15. A non-transitory machine-readable storage medium having embodied thereon instructions executable by one or more machines to perform operations comprising:
monitoring errors in software to identify types for the errors and individual programmers responsible for the errors; and
automatically create a customized learning plan for online education for one or more individual programmers based on the types of errors identified by the bug tracking module and the individual programmers responsible for those errors.

16. The non-transitory machine-readable storage medium of claim 15, wherein the monitoring of errors includes using a bug tracking module in a development or quality control system used to create the software.

17. The non-transitory machine-readable storage medium of claim 15, further comprising retrieving additional information about the one or more individual programmers from a server and utilizing the additional information when automatically creating the customized learning plan.

18. The non-transitory machine-readable storage medium of claim 17, wherein the additional information includes job description.

19. The non-transitory machine-readable storage medium of claim 17, wherein the additional information includes start date.

20. The non-transitory machine-readable storage medium of claim 17, further comprising providing a user interface for an administrator to create courses for use in learning plans, the user interface including one or more selectable menus for selecting job descriptions corresponding to created courses.
